(19) United States
(12) Patent Application Publication
(10) Pub. No.: US 2010/0309196 A1
(43) Pub. Date: Dec. 9, 2010

(54) METHODS AND APPARATUS FOR PROCESSING RELATED IMAGES OF AN OBJECT BASED ON DIRECTIVES

(76) Inventor: Mark CASTLEMAN, Austin, TX (US)

Correspondence Address: COOLEY LLP;ATTN: Patent Group, Suite 1100, 777 - 6th Street, NW, WASHINGTON, DC, 20001, US

(21) Appl. No.: 12/480,432

(22) Filed: Jun. 8, 2009

(51) Int. Cl. G06T 1/00

(52) U.S. Cl. 345/418

(57) ABSTRACT

In one embodiment, a processor-readable medium can store code representing instructions that when executed by a processor cause the processor to receive a set of directives from a host device. The set of directives can define an aspect of a media resource. A set of target locations can be defined within a canvas displayed at a communication device based on the set of directives. An image can be selected from a set of images for display at a target location from the set of target locations based on the set of directives. Each image from the set of images can represent a perspective view of an object.

### RELATED APPLICATION

This application is related to co-pending U.S. patent application bearing attorney docket no. SWAK-002/00US 311665-2001, filed on same date herewith, entitled “Methods and Apparatus for Selecting and/or Displaying Images of Perspective Views of an Object at a Communication Device,” which is incorporated herein by reference in its entirety.

### BACKGROUND

Embodiments relate generally to processing of images, and, in particular, to selection and display of images of an object at a communication device so that movement of the object can be represented.

Processing of data at a device to represent movement of an object within a display for interactive media (e.g., games), simulations, and/or so forth can be computationally expensive. For example, real-time processing of geometric models (e.g., three-dimensional (3D) geometric models, two-dimensional (2D) geometric models), 3D and/or 2D rendering, and/or so forth can require relatively large memory buffers and/or streamlined processing pipelines dedicated to these types of processing. Some devices, such as mobile devices, that have relatively limited processing resources may not be capable of representing motion of an object on a display in a desirable fashion using known data processing techniques. For example, a mobile phone with limited processing resources is typically not capable of real-time processing of a geometric model of an object at a speed that is practical for use in an application and/or while performing other necessary operations.

Thus, a need exists for methods and apparatus for processing related images of an object so that movement of an object can be represented.

### SUMMARY

In one embodiment, a processor-readable medium can store code representing instructions that when executed by a processor cause the processor to receive a set of directives from a host device. The set of directives can define an aspect of a media resource. A set of target locations can be defined within a canvas displayed at a communication device based on the set of directives. An image can be selected from a set of images for display at a target location from the set of target locations based on the set of directives. Each image from the set of images can represent a perspective view of an object.

### BRIEF DESCRIPTION OF THE DRAWINGS

FIG. 1 is a schematic diagram that illustrates communication devices in communication with a host device via a network, according to an embodiment.

FIGS. 2A through 2E are schematic diagrams that illustrate images and/or glyphs displayed on a canvas of a communication device 250, according to an embodiment.

FIG. 3 is a schematic diagram that illustrates several images from a set of images selected and displayed based on paths associated with directives, according to an embodiment.

FIG. 4 is a flowchart that illustrates a method for displaying an image from a set of images, according to an embodiment.

FIG. 5 is a diagram of a table that includes image selection information, according to an embodiment.

FIG. 6 is a schematic diagram that illustrates orientation indicators associated with images from a set of images and neighbor relationships between images from the set of images, according to an embodiment.

FIG. 7 is a flowchart that illustrates a method for selecting and displaying an image based on a directive and image selection information, according to an embodiment.

FIG. 8 is a diagram of a table that illustrates a multi-tiered map of neighbor relationships, according to an embodiment.

FIG. 9 is an illustration of a directive including a directive description portion and a directive content portion, according to an embodiment.

FIG. 10 is a flowchart that illustrates method for defining and distributing a group of directives, according to an embodiment.

### DETAILED DESCRIPTION

A communication device can be configured to define (e.g., determine), for example, an order (e.g., a sequence, a serial order), a location (e.g., a target location), and/or a timing (e.g., a specified start time, a time period) for displaying images of an object so that a movement (e.g., a translational movement, a rotational movement about several non-parallel axes, oscillating movement) of the object can be represented. The images can be from a set of images where each image represents (e.g., depicts an illustration of) a perspective view of the object. For example, images from a set of images of an airplane can be serially displayed within a specified time period at various target locations within a canvas of a communication device to represent, for example, a barrel roll of the airplane across the canvas. In some embodiments, a set of images of an object can collectively be processed at a communication device as an image resource (e.g., as a single image resource or object) and can be referred to as such.

In some embodiments, one or more images from a set of images of an object can be selected and/or displayed (e.g., displayed at a target location and/or at a specified time) at a communication device based on image selection information associated with the set of images. For example, one or more images from a set of images of an object can be selected and/or displayed at a communication device based on image selection information such as orientation indicators and/or a map of neighbor relationships that are associated with the set of images. The image selection information can be included in, for example, a metadata file associated with the set of images. In some embodiments, each of the orientation indicators can be, for example, an indicator of at least a component of an orientation of the object within an image. The orientation can be with respect to an origin position (e.g., a start position) of the object. For example, an orientation indicator can indicate that an image represents an object rotated around and/or along a specified axis with respect to an origin position (which can be represented within a separate image) or is moved away from an origin position. In some embodiments, the map of neighbor relationships can, for example, be used to determine which images from a set of images can be selected and/or displayed after a specified image from the set of images has been selected and/or displayed. In some embodiments, a set of images and a metadata file associated with the set of images can collectively be processed at a communication device as an image resource (e.g., as a single image resource or object) and can be referred to as such.

In some embodiments, images from a set of images of an object can be selected and/or displayed (e.g., displayed at a target location and/or at a specified time) at a communication device based on at least a portion of a directive (or a path defined at a communication device based on the directive). For example, images from a set of images of an object can be selected and/or displayed based on a description within a directive, a parameter value included in a directive, compressed sensor data included in the directive, a characteristic of path defined within a display based on a directive, and/or so forth. In some embodiments, for example, one or more images from a set of images can be selected and/or displayed at one or more locations along a path (e.g., moved over the path, moved near a path) defined within a display of a communication based on a directive. In some embodiments, for example, one or more images from a set of images can be selected and/or displayed along or near a path with a timing (e.g., during a specified time period) determined at the communication device based on, for example, a portion of a directive used to define the path. Thus, images from a set of images can be dynamically selected and/or displayed at a communication device in response to directives, for example, as they are received.

In some embodiments, a directive received at a communication device (and/or used to define a path) can be defined, at least in part, by a user at another communication device. In some embodiments, the directive can be pushed to the communication device from the other communication device, for example, via a host device. In some embodiments, the directive can be downloaded by (e.g., pulled by) the communication device from the host device via a network. In some embodiments, the directive can be used to trigger, for example, display of a visual resource (e.g., a glyph) at the communication device and/or playback of an audio resource.

As used in this specification, the singular forms “a,” “an” and “the” include plural referents unless the context clearly dictates otherwise. Thus, for example, the term “a communications device” is intended to mean a single communications device or multiple communications devices; and “network” is intended to mean one or more networks, or a combination thereof.

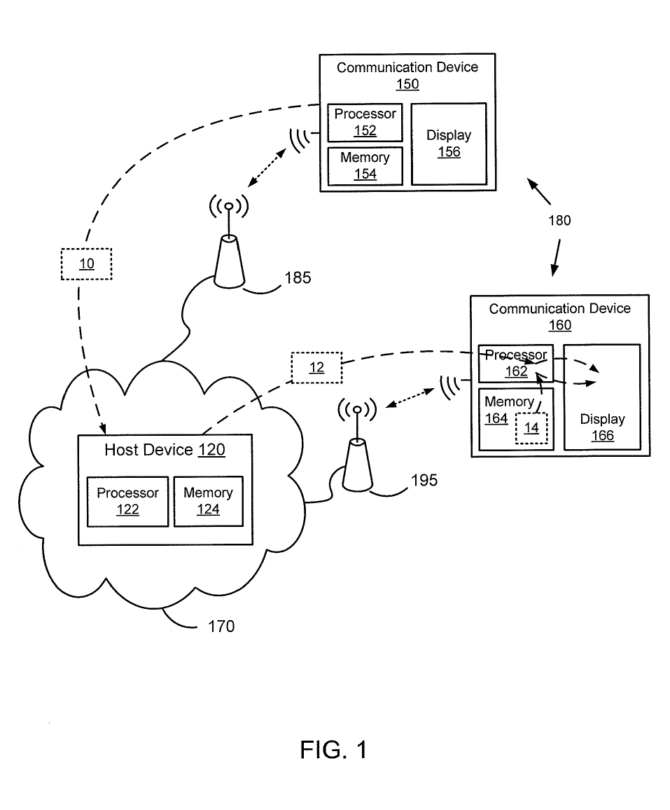

FIG. 1 is a schematic diagram that illustrates communication devices 180 in communication with a host device 120 via a network 170, according to an embodiment. Specifically, communication device 150 is configured to communicate wirelessly with the host device 120 via a gateway device 185. Similarly, communication device 160 is configured to communicate wirelessly with the host device 120 via a gateway device 195. The network 170 can be any type of network (e.g., a local area network (LAN), a wide area network (WAN), a virtual network, a telecommunications network) implemented as a wired network and/or a wireless network with one or more segments in a variety of environments such as, for example, an office complex.

In some embodiments, each of the communication devices 180 can be, for example, a computing entity (e.g., a personal computing device), a mobile phone, a monitoring device, a personal digital assistant (PDA), and/or so forth. Although not shown, in some embodiments, each of the communication devices 180 can have one or more network interface devices (e.g., a network interface card). In some embodiments, each of the communication devices 180 can function as a source device and/or as a destination device. Although shown as wireless communication devices in FIG. 1, in some embodiments, one or more of the communication devices 180 can be configured to communicate over the network 170 via a wire, or alternatively can be a wired communication device without wireless communication capabilities. In some embodiments, the communication devices 180 can be referred to as client devices, and processing at the communication devices 180 can be referred to as client-side processing.

As shown in FIG. 1, the communication device 160 has a processor 162, a memory 164, and a display 166. The memory 164 can be, for example, a random-access memory (RAM), a memory buffer, a hard drive, and/or so forth. The processor 162 of the communication device 160 can be configured to access (e.g., process, select) one or more images from a set of images 14 stored in the memory 164 of the communication device 160. In some embodiments, each image from the set of images 14 can represent (or can include) a perspective view of an object. In some embodiments, the set of images 14 can include images of any type of object such as a vehicle, a toy, a tool, an animal, and/or a person. In some embodiments, the set of images 14 can include images of imaginary objects and/or the set of images 14 can include images of objects that may or may not be interacting. In some embodiments, the set of images can include images of objects in one or more states (e.g., a solid state, an idle state, a destroyed state).

The processor 162 of the communication device 160 can be configured to define (e.g., determine), for example, an order (e.g., a sequence, a serial order), a target location, a timing, and/or so forth for displaying images from the set of images 14 of the object so that a movement (e.g., a translational movement, a rotational movement) of the object can be represented. For example, the set of images 14 can include images of a baseball in various positions (e.g., in various stages of rotation). The processor 162 of the communication device 160 can be configured to trigger serial display of images from the set of images 14 within the display 166 so that translational movement and/or rotational movement of the baseball within the display 166 can be represented. In some embodiments, processing related to the set of images 14 (e.g., selecting images from the set of images, determining a timing for displaying images from the set of images) can be performed at an image processing module (not shown) of the communication device 160.

In some embodiments, the set of images 14 can be associated with image selection information that can be used by the processor 162 to select one or more images from the set of images 14 and/or display (e.g., display at a target location and/or at a specified time) the image(s) from the set of images 14 at the communication device 160. In some embodiments, the set of images 14 can be associated with image selection information, such as orientation indicators and/or a map of neighbor relationships. For example, in some embodiments, an image from the set of images 14 can be selected based on an orientation indicator associated with the image. The image can then later be displayed during a time period at one or more target locations within the display 166 of the communication device 160. The time period and/or target location(s) can be determined based on the orientation indicator associated with the image. Processing of the set of images 14 can similarly be performed based on a map of neighbor relationships. In some embodiments, for example, a first image from the set of images 14 can be selected for display at the communication device 160 based on a map of a neighbor relationship between the first image and a second image (from the set of images 14) already being displayed at the communication device 160.

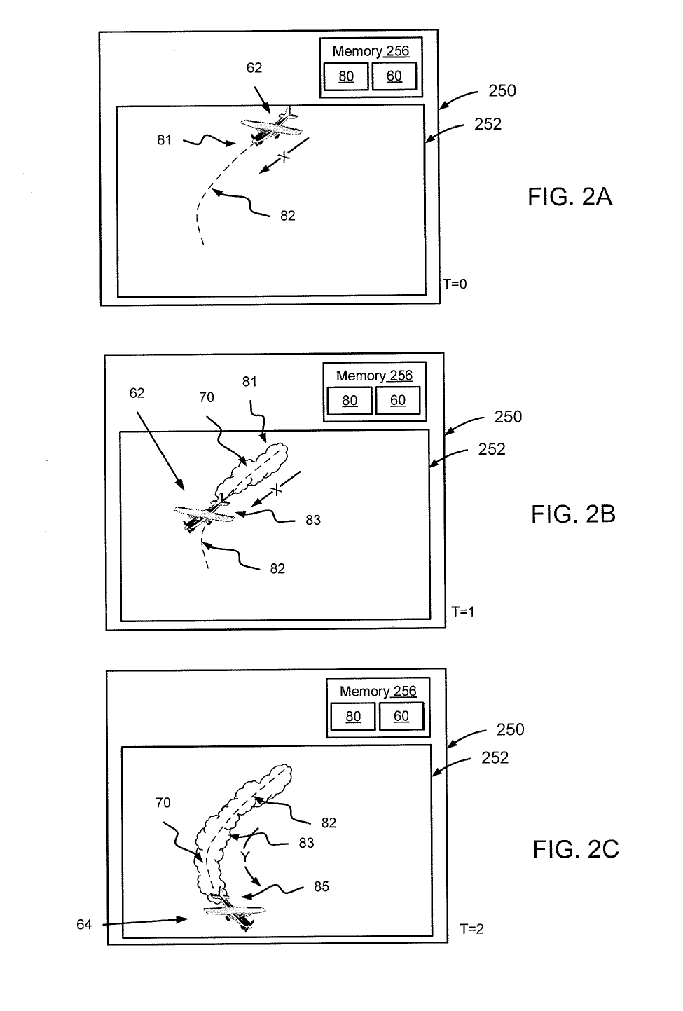

In some embodiments, processing related to image selection information associated with the set of images 14 can be performed at an image processing module (not shown) of the communication device 160. More details related to image selection information, such as maps of neighbor relationships and/or orientation indicators, that can be associated with a set of images and used to select an image for display at a communication device are described in connection with FIGS. 2 through 8.

In some embodiments, the set of images 14 of the object can collectively be processed at the communication device 160 as an image resource (e.g., as a single image resource or object) and can be referred to as such. For example, the set of images 14 can be downloaded from, for example, a host device and stored in a single array. The set of images 14 can be stored together and/or accessed from a library of image resources as a single entity. In some embodiments, the set of images can be processed as a single entity based on its association with a metadata file that includes image selection information. In some embodiments, the memory 164 can be a buffer where the set of images 14 are loaded as a single entity in response to a request from an application of the communication device 160.

In some embodiments, the library of image resources can be, for example, downloaded and/or installed independent of an application (and/or other module) at the communication device 160 used to process images from the library of image resources and/or directives. In some embodiments, image resources can be added and/or removed from the library of image resources without modifying (or substantially without modifying) an application (and/or other module) at the communication device 160 configured to process the image resources and/or directives.

As shown in FIG. 1, the processor 162 of the communication device 160 is configured to receive a directive 12 from host device 120. In some embodiments, the processor 162 can be configured to select an image from the set of images 14 and/or trigger display of the image at a target location and/or with a specified timing based on one or more portions of the directive 12 (or a portion of a path defined using the directive 12). For example, the processor 162 can be configured to select an image for display along a path defined within the display 166 of the communication device 160 during a specified time period based on the directive 12. In some embodiments, the directive 12 can be configured to trigger processing of (e.g., rendering of, display of) a media resource such as a visual resource (e.g., a glyph) and/or an audio resource. For example, in some embodiments, the directive 12 can include compressed sensor data that can be used to trigger display of a glyph (e.g., an alphanumeric letter, an outline of a shape). In some embodiments, processing related to directives can be performed at a directive processing module (not shown) of the communication device 160. In some embodiments, the directive 12 received at communication device 160 can be referred to as an input directive or as an incoming directive. Because the communication device 160 can be a destination of the directive 12, the communication device 160 can be referred to as a destination communication device.

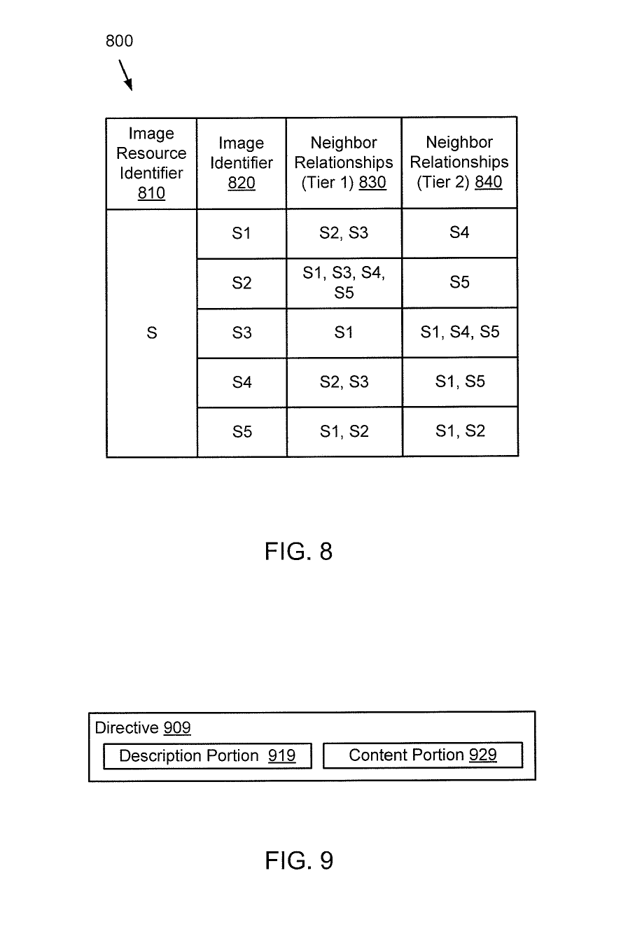

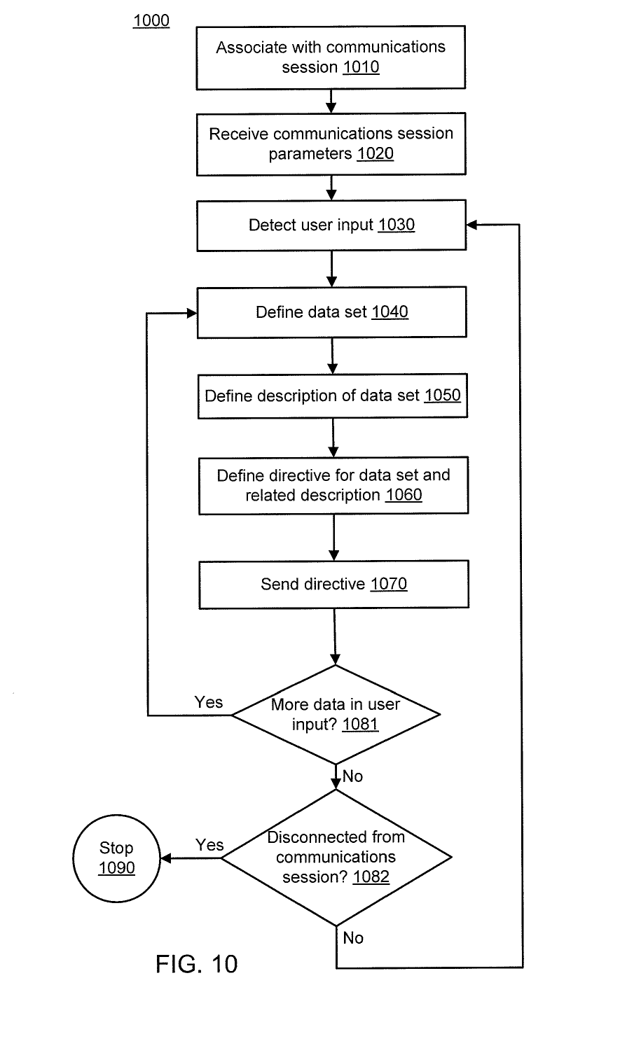

Similar to communication device 160, the communication device 150 has a processor 152, a memory 154, and a display 156. As shown in FIG. 1, the communication device 150 can be configured to define a directive 10 that can be sent to host device 120. The directive 10 can be defined at the communication device 150 in response to an interaction of a user with the communication device 150. For example, in some embodiments, the directive 10 can include compressed sensor data produced based on an interaction of a user with the display 156 (e.g., touch display) or other type of user interface (not shown) associated with (e.g., included in) the communication device 150. For example, in some embodiments, the directive 10 can be defined in response to a finger movement on a touch screen display of the communication device 150. In some embodiments, communication device 150 can be configured to perform a function associated with communication device 160, and vice versa. In some embodiments, the directive 10 defined at and sent from communication device 150 can be referred to as an output directive or as an outgoing directive. Because the communication device 150 can be a source of the directive 10, the communication device 150 can be referred to as a source communication device. In some embodiments, the communication device 150 can be a remote device with respect to communication device 160, and vice versa. More details related to defining and processing of directives are discussed in connection with FIGS. 9-10, and in connection with co-pending U.S. patent application bearing attorney docket no. SWAK-001/00US 311665-2002, filed on same date herewith, and entitled “Methods and Apparatus for Distributing, Storing, and Replaying Directives within a Network;” co-pending U.S. patent application bearing attorney docket no. SWAK-001/01US 311665-2005, filed on same date herewith, and entitled “Methods and Apparatus for Distributing, Storing, and Replaying Directives within a Network;” co-pending U.S. patent application bearing attorney docket no. SWAK-001/02US 311665-2006, filed on same date herewith, and entitled “Methods and Apparatus for Distributing, Storing, and Replaying Directives within a Network;” and co-pending U.S. patent application bearing attorney docket no. SWAK-001/03US 311665-2007 filed on same date herewith, and entitled “Methods and Apparatus for Distributing, Storing, and Replaying Directives within a Network;” each of which is incorporated herein by reference in its entirety.

In some embodiments, the directive 12 can be associated with the directive 10. For example, in some embodiments, the directive 12 can be a copy of the directive 10. In other words, the directive 10 can be pushed to the host device 120 from communication device 150, copied at the host device 120, and forwarded (pushed or pulled) from the host device 120 to the communication device 160 as directive 12. In some embodiments, the directive 12 can be defined at a processor 122 of the host device 120 based on the directive 10. For example, the directive 12 can have a data portion (e.g., a payload portion) equal to directive 10, but directive 12 can have routing portion that is different than a routing portion included in directive 10. The different routing portion can be defined at the host device 120.

In some embodiments, directive 12 and/or directive 10 can be stored at a memory 124 of the host device 120. For example, the directive 12 can be stored at the host device 120 until the directive 12 is requested by communication device 160. In response to the request, the directive 12 can be sent to the communication device 160. In some embodiments, the directive 10 can be stored at the memory 124 of the host device 120 until a request for a directive is received from the communication device 160. In response to the request, the host device 120 can be configured to define directive 12 based on directive 10 and can send directive 12 to the communication device 160. In other words, the directive 12 can be pulled from the host device 120 by the communication device 160.

The host device 120 can be any type of device configured to send data to and/or receive data from one or more of the communication devices 180 via the network 170. In some embodiments, the host device 120 can be configured to function as, for example, a server device (e.g., a web server device), a network management device, and/or so forth.

In some embodiments, one or more portions of the host device 120 and/or one or more portions of the communication devices 180 can include a hardware-based module (e.g., a digital signal processor (DSP), a field programmable gate array (FPGA)) and/or a software-based module (e.g., a module of computer code, a set of processor-readable instructions that can be executed at a processor). In some embodiments, one or more of the functions associated with the host device 120 (e.g., the functions associated with the processor 122) can be included in one or more modules. In some embodiments, one or more of the functions associated with the communication devices 180 (e.g., functions associated with processor 152) can be included in one or more modules. In some embodiments, communication device 150 can be configured to perform one or more functions associated with communication device 160, and vice versa. In some embodiments, one or more of the communication devices 180 can be configured to perform one or more functions associated with the host device 120, and vice versa.

FIGS. 2A through 2E are schematic diagrams that illustrate images and/or glyphs displayed on a canvas 252 of a communication device 250, according to an embodiment. The canvas 252 can be, for example, a background image, or a collection of background images, displayed within a display (not shown) of the communication device 250. FIGS. 2A through 2E each illustrates a snapshot from a sequence of snapshots of the canvas 252 as images of an airplane are moved within the canvas and as smoke glyphs are displayed within the canvas 252. A time T of each snapshot is shown in each of FIGS. 2A through 2E. For example, FIG. 2B is a snapshot of the canvas 252 at time T=1, and FIG. 2C is a snapshot of the canvas 252 at time T=2, which is after time T=1.

Specifically, FIG. 2A is a schematic diagram that illustrates an image 62 (of the airplane) selected from a set of images 60 (of the airplane) and displayed on a beginning portion 81 of a path 82 within the canvas 252 at time T=0. As shown in FIG. 2A, the set of images 60 are stored in a memory 256 of the communication device 250. The image 62 is a perspective view of the airplane, as are each of the images from the set of images 60. Each of the images from the set of images 60 (of the airplane) is a static image (e.g., a static compressed image, a graphics interchange format (GIF) image, a joint photographic experts group (JPEG) image, a tagged image file format (TIFF) image). Each of the images is not, for example, a real-time view of a three-dimensional model that can be dynamically rendered at the communication device 160. In some embodiments, the set of images 60 can be referred to as a stack of images.

The path 82 (which is illustrated as a dashed line in FIG. 2A) can be defined by, for example, the communication device 250 based on one or more directives 80 received at the communication device 250. As shown in FIG. 2A, the set of images 60 can be stored in the memory 256 of the communication device 250. The directives 80 can include, for example, one or more parameter values that can be used by the communication device 250 to define the path 82. In some embodiments, for example, the parameter value(s) can include a parameter value representing a radius of curvature of a path, a path width parameter value, a path length parameter value, a parameter value representing a directionality (e.g., a set of vectors) of the path, a path velocity parameter value, a path orientation parameter value, a parameter value representing a time period associated with the path (e.g., a time period that a portion of the path can be accessed), and/or so forth.

FIG. 2B is a schematic diagram that illustrates the image 62 of the airplane selected from the set of images 60 and displayed at a middle portion 83 of the path 82 (shown in FIG. 2A) at time T=1. The image 62 of the airplane is moved along direction X starting at time T=0 from the beginning portion 81 of the path 82 (shown in FIG. 2A) to the middle portion 83 of the path 82 shown in FIG. 2B at time T=1. FIG. 2B also illustrates a portion of a smoke glyph 70 displayed along the path 82 up to a rear portion of the image 62 of the airplane. Specifically, the portion of the smoke glyph 70 is displayed from the beginning portion 81 of the path 82 to the middle portion 83 of the path 82.

FIG. 2C is a schematic diagram that illustrates an image 64 of the airplane selected from the set of images 60 and displayed at an end portion 85 of the path 82 at time T=2. The image 64 of the airplane is a perspective view of the airplane that is different than a perspective view of the airplane represented (e.g., depicted) within image 62. The image 64 of the airplane is moved along direction Y starting at (or starting shortly after) time T=1 from the middle portion 83 of the path 82 (also shown in FIG. 2B) to the end portion 85 of the path 82 shown in FIG. 2C at time T=2.

The image 64 of the airplane (shown in FIG. 2C) can be displayed immediately after display of the image 62 of the airplane (shown in FIG. 2B) is completed. For example, image 64 of the airplane can be displayed in a frame (e.g., a frame produced by a display at a specified frequency) directly following a last frame within which the image 62 of the airplane is displayed. In some embodiments, the image 64 of the airplane and the image 62 of the airplane can be concurrently displayed for a short period of time.

FIG. 2D is a schematic diagram that illustrates an image 66 of the airplane selected from the set of images 60 and displayed between the path 82 and a path 84 at time T=3. The path 84 (which is illustrated as a dashed line in FIG. 2D) can be defined by, for example, the communication device 250 based on one or more of the directives 80 received at the communication device 250. The image 66 of the airplane is a perspective view of the airplane that is different than the perspective views of the airplane represented (e.g., depicted), respectively, within image 62 and image 64. The image 66 of the airplane is moved along direction W within a space 86 from the end portion 85 of the path 82 starting at (or starting shortly after) time T=2 to a beginning portion 87 of the path 84 at time T=3.

In some embodiments, one or more of the directives 80 can be defined at a source communication device (not shown) in response to, for example, a direct user interaction with or a user-triggered interaction with the source communication device. For example, the directives 80 that can be used to define the path 82 and the path 84 at the communication device 250 can be defined in response to, for example, finger strokes of a user at a source communication device (not shown). Accordingly, a shape of a first finger stroke of the user at the source communication device can substantially correspond with the path 82, and a shape of a second finger stroke of the user (which is separate from the first finger stroke) at the source communication device can substantially correspond with the path 84.

FIG. 2E is a schematic diagram that illustrates an image 68 of the airplane selected from the set of images 60 and displayed at the beginning portion 87 of the path 84 at time T=4. The image 68 of the airplane is a perspective view of the airplane that is different than the perspective views of the airplane represented (e.g., depicted), respectively, within image 62, image 64, and image 66. The image 68 of the airplane is moved along direction Z, starting at (or starting shortly after) time T=3, from the beginning portion 87 of the path 84 to an end portion 89 of the path 84 at time T=4 as shown in FIG. 2E. FIG. 2E also illustrates a smoke glyph 71 displayed along the path 84 up to a rear portion of the image 68 of the airplane.

The images from the set of images 60 can be selected and displayed within the canvas 252 (as shown in FIGS. 2A through 2E) based on, for example, one or more rules (not shown in FIGS. 2A through 2E), image selection information associated with the set of images 60 (e.g., a map of neighbor relationships, a set of orientation indicators), and/or one or more portions of the directives 80 used to define path 82 and/or path 84. The rule(s) can be included in, for example, an algorithm executed at the communication device 250 and/or can be included in a user preference that can be accessed from a memory (not shown) of the communication device 250.

For example, image 62 of the airplane can be selected from the set of images 60 based on at least a portion of the directive 80 used to define the path 82 and/or based on a characteristic of the path 82. The image 62 of the airplane can be moved along direction X at a specified velocity starting at time T=0 from the beginning portion 81 of the path 82 (shown in FIG. 2A) to the middle portion 83 of the path 82 shown in FIG. 2B at time T=1 (shown in FIG. 2B) based on a user preference. A transition from image 62 of the airplane to image 64 of the airplane can be determined based on one or more rules and/or based on a map of neighbor relationships.

Similarly, the smoke glyph 70 and/or the smoke glyph 71 can be selected and/or displayed within the canvas 252 based on, for example, one or more rules, image selection information associated with the glyphs (e.g., a map of neighbor relationships, a set of orientation indicators), and/or one or more portions of the directives 80 used to define path 82 and/or path 84. For example, portions of the smoke glyph 71 can be displayed along the path 84 (as shown in FIG. 2E) based on a user preference and/or based on the image 68 being an image of an airplane.

As shown in FIGS. 2A through 2E, at least some of the images can be selected from the set of images 60 and displayed on the canvas 252 as the paths (e.g., path 82) are defined. For example, image 62 and image 64 are selected from the set of images 60 and displayed on the canvas 252 after path 82 is defined, but before path 84 is defined. Image 66 and image 68 are selected from the set of images 60 after path 84 is defined. In some embodiments, images from a set of images can be selected and/or displayed as portions of a path are defined based on a directive.

As shown in FIGS. 2A through 2E, images from the set of images 60 are serially displayed. In other words, the images selected from the set of images 60 and displayed on the canvas 252 collectively define a serial sequence of images. Specifically, the images are displayed in the following order: image 62, image 64, image 66, and image 68. In alternative embodiments, the serial order (or sequence) with which the images from the set of images 60 are selected and/or displayed on the canvas 252 could be different if path 84 were defined before path 82. Path 84 could be defined before path 82 if the directive(s) 80 used to define path 84 was received and processed at the communication device 250 before the directive(s) 80 used to define path 82 was received and processed at the communication device 250.

In some embodiments, the set of images 60 can include more images than image 62, image 64, image 66 and image 68 that are respectively shown in FIGS. 2A through 2E. In some embodiments, larger and/or smaller images of the airplane than those shown in FIGS. 2A through 2E can be included in the set of images 60 and used by the communication device 250 to represent movement of the airplane into and/or out of a plane of the canvas 252.

Although not shown, in some embodiments, movement of the image 66 of the airplane in the space 86 between the end portion 85 of the path 82 and the beginning portion 87 of the path 84 can be along a path (not shown). In some embodiments, the path can be defined at the communication device 250 based on a directive (such as directives 80). In some embodiments, the communication device 250 can be configured to select and/or display (e.g., display with a specified timing and/or at one or more target location(s)) one or more images of the airplane based on an algorithm related to transitions in a space between one path and another path that are separated (e.g., not connected, not coupled). In some embodiments, the communication device 250 can be configured to trigger display of default images from a set of images in a space between paths. In some embodiments, the default images can be displayed based on a default sequence for displaying the images.

Although not shown, in some embodiments, the communication device 250 can be configured to select and/or display (e.g., display with a timing and/or at a target location(s)) one or more images of the airplane from the set of images 60 based on an algorithm after processing associated with a final directive from the directives 80 is completed. The communication device 250 can be configured to select and/or display one or more images of the airplane from the set of images 60 until another of the directives 80 is received. For example, after processing based on the directive(s) 80 associated with path 84 is completed the communication device 250 can be configured to select and/or display (e.g., display with a specified timing and/or at one or more target location(s)) one or more images of the airplane based on an algorithm until a new directive (not shown) is received at the communication device 250. In some embodiments, for example, the communication device 250 can be configured to trigger display of default images (e.g., a default group of images) from the set of images 60 until a new directive (not shown) is received. In some embodiments, the default images can be displayed based on a default sequence for displaying the images.

In some embodiments, one or more of the images from the set of images 60 can be selected and/or displayed within the canvas 252 based on a directive from the directives 80 associated with an audio resource such as an audio file. Specifically, the directive from the directives 80 can include a payload associated with an audio resource. In some embodiments, the audio resource can be, for example, a stock sound clip and/or can be defined at, for example, a source communication device by a user (e.g., a voice of a user). In some embodiments, a directive that includes (and/or is linked to) an audio resource can also include one or more parameter values that can be used to define a path. For example, a communication device can be configured to select and/or display one or more images from a set of images based on playback of an audio resource associated with one or more directives. In some embodiments, the images can be selected and/or displayed in accordance with (e.g., synchronously with) one or more portions of a waveform associated with playback of the audio resource. For example, a set of images of an airplane can be selected and/or displayed synchronously on a canvas with playback of jet engines sounds.

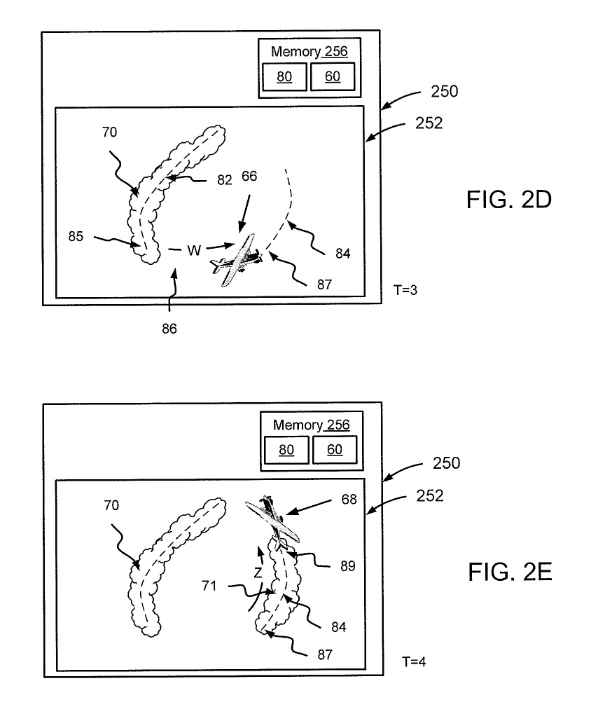

FIG. 3 is a schematic diagram that illustrates several images from a set of images 32 selected and displayed based on paths 39 associated with directives 30, according to an embodiment. The images can be displayed at a display 356 of a communication device 350. Images from the set of images 32 can be selected and displayed at one or more target locations along one or more portions of paths 39. The paths 39 include path 31, path 33, and path 35. The set of images 32 includes images N₁ through N_{Q}, and the directives 30 include directive W1, directive W2, and directive W3.

As shown in FIG. 3, path 31 (shown as a dashed line) is defined using directive W3, path 33 (shown as a dashed line) is defined using directive W2, and path 35 (shown as a dashed line) is defined using directive W1. In some embodiments, a processor (not shown in FIG. 3) of a communication device 350 can be configured to interpret one or more portions of the directives 30 and can be configured to define the paths 39 within the display 356. For example, the directive W3 can include data (e.g., binary data) that can be used by a processor of the communication device 350 to define path 31, which has a curved portion 36, within the display 356. As shown in FIG. 3, path 33 is disposed between path 31 and path 35. Specifically, one end of path 33 is connected with path 31 and the other end of path 33 is connected with path 35. In some embodiments, the paths 39 shown in FIG. 3 may or may not be made visible to a user of the communication device 350.

As shown in FIG. 3, image N₁ is selected and statically displayed at target location A on path 31, and image N₂ is selected and statically displayed at target location C on path 33. Image N₃ is selected and displayed starting at target location B on path 31. Image N₃ is moved along path 31 from target location B to target location C on path 33 along direction E. In other words, image N₃ is displayed starting at target location B and moved along portions of path 31 and portions of path 33 to target location C. In some embodiments, the movement of image N₃ along path 31 and path 33 can be implemented by displaying image N₃ at multiple different times (e.g., mutually exclusive times) at multiple different target locations between target location B and target location C as a series of static images. The image N₁, the image N₂, and the image N₃ can be displayed with a specified timing (e.g., starting at specified times and/or during specified time periods).

In this embodiment, images from the set of images 32 are serially displayed (e.g., serially displayed at mutually exclusive display start times, serially displayed during substantially mutually exclusive periods of times). In some embodiments, for example, image N₁ can be displayed immediately after display of image N₂ is completed, and image N₃ can be displayed immediately after display of image N₂ is completed. In some embodiments, one or more images from the set of images 32 can be displayed during overlapping periods of time (e.g., during overlapping periods of time that have mutually exclusive display start times).

Although the communication device 350 is configured to trigger display of several of the set of images 32 along at least portions of the paths 39, in some embodiments, the communication device 350 can be configured to trigger display of one or more of the images 32 at target locations that are not along the paths 39. For example, the communication device 350 can be configured to trigger display of one or more of the set of images a specified distance from a portion of one or more of the paths 39 and/or a glyph associated with one or more of the paths 39.

In some embodiments, images can be selected from the set of images 32 and/or displayed (e.g., displayed at target locations along (or a specified distance from) one or more portions of the paths 39, displayed at specified times (e.g., during specified time periods)) based on, for example, one or more parameter values associated with the portion(s) of the path(s) 39. The parameter value(s) can define one or more characteristics of portion(s) of the path(s) 39. In some embodiments, the parameter value(s) can be included in directives 30 associated with the portion(s) of the path(s) 39 and/or can be calculated at the communication device 350 based any data included in the directives 30 associated with the portion(s) of the path(s) 39. In some embodiments, the parameter value(s) can include, for example, a radius of curvature of a path, a path width, a path length, a directionality (e.g., a set of vectors) of the path, a path velocity, a path orientation, a time period associated with the path (e.g., a time period that a portion of the path can be accessed), and/or so forth.

In some embodiments, the images from the set of images 32 can be selected and/or displayed at one or more target locations and/or at one or more specified times (e.g., during specified time periods) based on one or more rules (e.g., a set of rules) stored at the communication device 350. For example, one or more conditions within a rule can be satisfied (or unsatisfied) based on a parameter value associated with a path 39 (e.g., a characteristic of a path 39 as defined by a parameter value). One or more actions within the rule can be performed (e.g., executed) in response to the condition(s) being satisfied (or unsatisfied). In some embodiments, the rules can be associated with one or more applications installed at the communication device 350, can be included in an algorithm that can be executed at the communication device 350, and/or can be included in one or more user preferences associated with the communication device 350.

In some embodiments, one or more rules can be included in a user preference that can be received at and/or stored in a memory (not shown) of the communication device 350. In some embodiments, one or more rules can be defined in response to an interaction of a user with the communication device 350. For example, during display of one or more of the set of images 32 at the display 356 of the communication device 350, a user of the communication device can toggle (e.g., toggle via a user interface) a setting that modifies one or more rules used to select and/or display images from the set of images 32. Thus, selection and/or display of images from the set of images 32 can be changed in real-time (e.g., during run-time). Specifically, selection and/or display of images from the set of images 32 before the setting is toggled can be performed based on a set of rules that is different than a set of rules used to perform selection and/or display of images from the set of images 32 after the setting has been toggled.

In some embodiments, one or more rules can be defined so that a specific type of motion is represented on the display 356 when the rule(s) are applied. In some embodiments, images from a set of images 356 of an object can be selected and/or displayed on the display 356 in a specified order (e.g., a specified sequence) at specified target locations during specified time periods based on a rules so that a specific type of movement of the object is represented within the display 356. For example, in some embodiments, rotational movement of an object around two non-parallel axes during a specified period of time can be represented within the display 356 in response to application of one or more rules at the communication device 350. In some embodiments, movement of an object into or out of the display 356 in response to application of one or more rules at the communication device 350.

In some embodiments, for example, the communication device 350 can be configured to select one or more of the set of images 32 and/or display selected the image(s) based on the portion(s) of the path(s) 39 being in a particular location. The image(s) can be displayed, for example, at target locations along (or a specified distance from) one or more portions of the paths 39 and/or displayed at specified times (e.g., during specified time periods). For example, the image N₁ can be selected and/or displayed at target location A at the end 37 of path 31 because the end 37 of path 31 is located within a specified area (not shown) within the display 356. The location of the end 37 of the path 31 within the specified area can be determined based on one or more parameter values included in directive W3. The parameter values included in directive W3 can be used at the communication device 350 to define the path 31 within display 356. In some embodiments, for example, the image N₂ can be selected and/or displayed at target location C because the path 33 has a specified portion within a particular quadrant or portion of the display 356.

In some embodiments, the communication device 350 can be configured to select one or more of the set of images 32 and/or display (e.g., display at a target location, display during a specified time period) the selected image(s) based on the portion(s) of the path(s) 39 having a specified shape (as defined within a parameter value(s) associated with the portion(s) of the path(s)). For example, the image N₂ can be selected and/or displayed at target location C because the path 33 is a straight line and/or because the path 33 has a length value greater than a specified threshold length value included, for example, a condition within a rule. In some embodiments, the shape of the path 33 can be defined within one or more parameter values associated with the path 33 (e.g., included in directive W2 used to define the path 33).

In some embodiments, for example, the image N₃ can be selected and/or displayed at target location B because path 31 has a specified radius of curvature (or a radius of curvature value greater than a threshold radius of curvature value included as a part of a condition within a rule). In some alternative embodiments, a different image than N₃ could be selected and/or displayed at a different target location (not shown) than target location B if the path 31 had a different radius of curvature than that shown in FIG. 3. In some embodiments, a number and/or placement of target locations at which images can be displayed can be determined based on a radius of curvature of a path. For example, a specified number of target locations can be included on a path that has a radius of curvature that exceeds a threshold radius of curvature value. In some alternative embodiments, for example, more than two images could be selected by the communication device 250 for display along path 31 if the radius of curvature of path 31 were greater than that shown in FIG. 3. Similarly, in some alternative embodiments, less than two images could be selected for display by the communication device 250 along path 31 if the radius of curvature of path 31 were less than that shown in FIG. 3.

In some embodiments, the communication device 350 can be configured to select one or more images from the set of images 32 and/or display (e.g., display at a target location, display during a specified time period) the selected image(s) based on the portion(s) of the path(s) 39 having a specified orientation (as defined within a parameter value(s) associated with the portion(s) of the path(s)). For example, the image N₂ can be selected and/or displayed at target location C because the path 33 is sloping in a particular direction within the display 356. Specifically, the slope of the path 33 can be determined by the communication device 350 based on a slope parameter value included in directive W2 (which is used to define path 33). The communication device 350 can be configured to trigger display of the image N₂ at target location C within display 356 because the slope parameter value satisfies a condition associated with a rule. In some embodiments, a slope value can be calculated, for example, based data included in a portion of directive W2.

In some embodiments, an image that has a specified orientation can be selected from a set of images based on a portion of a path having a concave portion (or convex portion) oriented in a specified fashion on a display. In other words, the image can be selected from a set of images so that the orientation of the image is based on the orientation of a curved portion of the path.

In some embodiments, the communication device 350 can be configured to select one or more of the set of images 32 and/or display (e.g., display at a target location, display during a specified time period) the selected image(s) based on one or more portions of the paths 39 having a specified orientation with respect to one or more portions of another of the paths 39. For example, the image N₂ can be selected and/or displayed at target location C because the path 33 is sloping towards path 35 and/or because the path 33 is sloping away from an end of path 31. The relationship between path 33 and path 31 can be determined based on one or more parameter values included in directive W2 and directive W3, respectively. In some embodiments, for example, the image N₁ can be selected and/or displayed at target location A at an end 37 of path 31 because the end 37 of path 31 is not connected to another of the paths. In some embodiments, for example, the image N₂ can be selected and/or displayed at target location C because the path 33 is connected with two paths—path 31 and path 35.

In some embodiments, the communication device 350 can be configured to select one or more images from the set of images 32 and/or display (e.g., display at a target location, display during a specified time period) the image(s) based on one or more portions (e.g., parameter values) of the directives 30. For example, the communication device 350 can be configured to trigger display of image N₂ at target location C on path 33 because the directive W2 includes one or more parameter values specifying that image N₂ should be displayed at target location C on path 33.

In some embodiments, a portion of a directive can indicate that an image with a specified orientation should be selected and displayed along a path defined using the directive. The specified orientation can be used by, for example, communication device 350 to determine a target location (or target locations) where the image (with the specified orientation) should be displayed along the path. In some embodiments, the directive can be defined at, for example, another communication device (not shown) and/or a host device (not shown) and sent to the communication device 350.

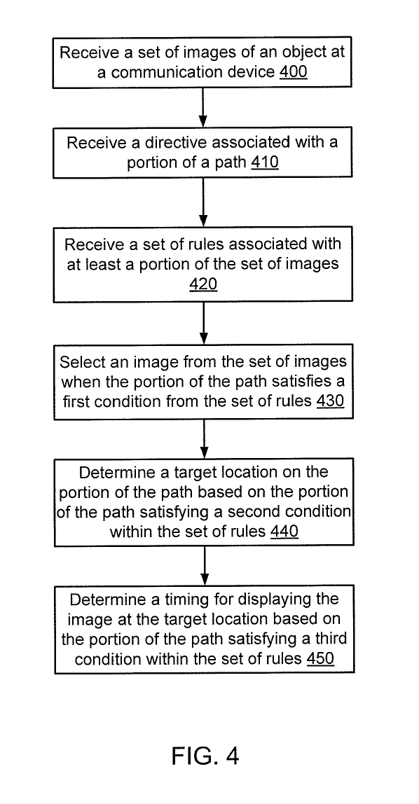

In some embodiments, the communication device 350 can be configured to select one or more images from the set of images 32 and/or display (e.g., display at a target location, display during a specified time period) the selected image(s) based on one or more orientation indicators. The orientation indicators can be, for example, an indicator of an orientation of an object as represented by an image from the set of images 32. In some embodiments, the orientation indicator associated with image N₁ can indicate a first orientation of an object as represented by image N₁ with respect to a second orientation (e.g., an origin position, a start position) of the object. In some embodiments, for example, an image (e.g., image N₃) from the set of images 32 of an object can be selected and/or displayed at a particular target location associated with one or more of the paths 39 based on the image being associated with an orientation indicator representing a specified orientation. More details related to orientation indicators are described in connection with FIGS. 5 through 8.

In some embodiments, the communication device 350 can be configured to select one or more images from the set of images 32 and/or display (e.g., display at a target location, display during a specified time period) the selected image(s) based on a map of neighbor relationships between images from the set of images 32. For example, image N₂ can be selected for display within the display 356 at target location B based on a neighbor relationship between image N₁ (which is selected for display at target location A) and image N₂ (which is to be displayed at target location C). More details related to neighbor relationships are described in connection with FIGS. 5 through 8.

In some embodiments, the communication device 350 can be configured to determine a timing for display of one or more of the set of images 32 based on a timing of processing one or more portions of the path(s) 39 and/or based on one or more rules. For example, image N₁ can be displayed at target location A as soon as the entire path 31 is determined (e.g., resolved) at the communication device 350 based on directive W3. In some embodiments, the image N₁ can be displayed at target location A as soon as a location (within display 356) of a portion of the path 31 associated with target location A is determined at the communication device 350 based on directive W3.

In some embodiments, the communication device 350 can be configured to trigger display of one or more of the set of images 32 at one or more times (e.g., during a specified time period) based on one or more portions (e.g., parameter values) of the directives 30. For example, the communication device 350 can be configured to trigger display of image N₂ at target location C on path 33 at a specified time in response to an instruction from the directive W2 to display the image N₂ at target location C on path 33 at the specified time (e.g., within a specified time slot). In some embodiments, the communication device 350 can be configured to trigger display of image N₂ at target location C a specified time period after display of, for example, image N₃ at target location B based on one or more parameter values included in directive W2 and/or based on one or more rules.

In some embodiments, images from the set of images 32 can be moved along one or more portions of the paths 39 based on, for example, a velocity associated with the portion(s) of the path(s) 39. For example, image N₃ can be moved along a portion of path 31 in accordance with direction E (as shown in FIG. 3) at a path velocity parameter value included the directive W3 and/or based on one or more rules (e.g., a rule included in a user preference). The image N₃ can be moved along a portion of path 33 in accordance with direction E (as shown in FIG. 3) at a path velocity parameter value included the directive W2 and/or included in one or more rules (e.g., a rule included in a user preference). If the path velocity parameter value associated with path 31 is different than the path velocity parameter value associated with path 33, a speed at which the image N₃ is moved along direction E by the communication device 350 can change at the transition between path 31 and path 33. In some embodiments, for example, the path velocity parameter value included in the directive W3 can correspond with (or can be proportional to) a speed with which the directive W3 is defined at a source communication device by a user. In some embodiments, image N₃ can be moved along direction E (as shown in FIG. 3) at a velocity defined within a user preference (e.g., within a rule included in the user preference) and/or during run-time at the communication device 350 by a user.

In some embodiments, the velocity can be calculated based on a path time period (e.g., a time period during which a portion of the path is available) and a path length associated with a portion of a path 39. In other words, different velocities can be associated with different (e.g., overlapping, mutually exclusive) portions of a path 39 (so that an image can be, for example, accelerated). For example, the path 31 can be associated with a direction D, a path length (not shown), and a time period. The direction D, the path length, and the time period can be specified within directive W3, which is used to define path 31. The time period and the path length can be used to determine, at the communication device 350, a velocity that can be associated with the entire path 31. Specifically, the velocity can be calculated at the communication device 350 based the time period divided by the path length. Accordingly, communication device 350 can be configured to trigger display of the image N₁ at target location A at a first time at the starting point of the path 31 (in accordance with direction D) as shown in FIG. 3. The image N₃ can be displayed at target location B at a second time after the first time. A duration between the first time and the second time can be calculated based on a product of the velocity and a distance (e.g., a length of a portion of the path length) between target location A and target location B. Other types of values such as an acceleration value, a deceleration value, a slope value, and/or so forth can similarly be calculated at the communication device 350.

Although not shown, in some embodiments, additional images from the set of images 32 can be displayed between target location B and target location C so that, for example, rotational movement of an object and be represented. In such instances the images displayed between target location B and target location C can be serially displayed between target location B and target location C along mutually exclusive portions of the path 31 and path 33. In some embodiments, the communication device 350 can be configured to select and/or display a predefined sequence of images from the set of images 32 between two or more target locations (e.g., between target location B and target location C).

In some embodiments, the paths 39 and/or other processing related to the paths 39 (e.g., selection and/or display of images from the set of images 32) can be scaled up, scaled down, or not scaled at the communication device 350. For example, the communication device 350 can be configured to determine whether or not one or more of the paths 39 would be, for example, too large or too small to be included within an area of the display 356 if defined as described within one or more of the directives 30. Accordingly, the communication device 350 can be configured to scale the path(s) 39 so that the path(s) 39 can fit within the area of the display 356 in a desirable fashion. In some embodiments, for example, movement of an image from the set of images 32 at a specified velocity can be scaled up and/or down depending on, for example, the processing capability of the communication device 350 and/or a size of the display 356.

Although not shown, in some embodiments, one or more images can be displayed periodically, randomly, and/or so forth at a target location (or target locations). For example, in some embodiments, image N₁ can be intermittently displayed at target location A during a specified period of time based on, for example, a rule and/or a portion of the directive used to define path 31.

Although not shown, in some embodiments, one or more glyphs can be displayed on (or near) one or more of the paths 39. In some embodiments, an application associated with (e.g., installed at, accessed from) the communication device 350 can be configured to include one or more glyphs along the path after the path is defined, or as the path is being defined within the display 356. For example, a line can be displayed along path 31 as path 31 is being defined within the display 356.

In some embodiments, the set of images 32 (which also can be referred to as a image resource) can be selected from library of sets of images (not shown). In some embodiments, the set of images 32 can be selected from the library of sets of images based on a user preference and/or a based on a canvas type. For example, a set of images that includes perspective views of a fish can be selected from a library of sets of images based on a canvas representing a underwater scene. Accordingly, images from the set of images of the fish can be selected for display on one or more paths defined based on a set of directives within the underwater scene during a time period.

In some embodiments, different sets of images (which can be related to different objects) can be processed within different canvases based on a single set of directives during various time periods. For example, a first set of images can be processed within a canvas based on a set of directives during a first time period. Later, during a second time period, a second set of images can be processed within the canvas (or a different canvas) based on the same set of directives during a second time period different than the first time period. In some embodiments, the processing of the set of directives during the different time periods using different sets of images can be triggered by, for example, a user. Because the different sets of images can be stored locally (and/or pre-loaded) at a communication device, processing the different sets of images during different processing time periods can be performed with a desirable level efficiency (e.g., with minimal instructions, with little interruption of real-time processing).

In some embodiments, the directives 30 can be stored at a host device (not shown) and/or another communication device (not shown). Each of the directives 30 can be retrieved from the host device and/or from the other communication device in response to a request from the communication device 350. In some embodiments, the directives 30 can be sent to (e.g., streamed to) the communication device 350 when the communication device 350 (and/or an application associated with the communication device 350) is available to receive the directives 30. In some embodiments, one or more of the directives 30 can be sent to the communication device 350 during a session (e.g., a communication session) with the host device and/or the other communication device.

In some embodiments, the directives 30 can be sent to the communication device 350 when the communication device 350 is available to receive the directives 30 and can be stored at the communication device 350. The directives 30 can be processed at the communication device 350 at a later time (e.g., at a later time in response to a request triggered by a user of the communication device 350). In some embodiments, one or more of the directives 30 can be sent in a group (e.g., within a data packet) to the communication device 350. In such instances, each of the directives 30 can be parsed from the group and processed at the communication device 350.

In some embodiments, each of the directives 30 can be sent (e.g., streamed), received, and/or processed in a particular order. In some embodiments, the directives 30 can be sent to the communication device 350 from, for example, a host in a particular order so that they can be processed at the communication device 350 in that order. Accordingly, the communication device 350 can be configured to process the directives 30 as they are received. In some embodiments, for example, each of the directives 30 can be processed at the communication device 350 in an order determined at the communication device 350 regardless of an order that the directives 30 are sent to (and/or received at) the communication device 350. The sequence for processing of the directives 30 can be specified within the directives 30 and/or within an instruction associated with the directives 30. More details related to ordering of directives and defining directives are described in FIGS. 9-10, and in co-pending U.S. patent application bearing attorney docket no. SWAK-001/00US 311665-2002, filed on same date herewith, and entitled “Methods and Apparatus for Distributing, Storing, and Replaying Directives within a Network;” co-pending U.S. patent application bearing attorney docket no. SWAK-001/01US 311665-2005, filed on same date herewith, and entitled “Methods and Apparatus for Distributing, Storing, and Replaying Directives within a Network;” co-pending U.S. patent application bearing attorney docket no. SWAK-001/02US 311665-2006, filed on same date herewith, and entitled “Methods and Apparatus for Distributing, Storing, and Replaying Directives within a Network;” and co-pending U.S. patent application bearing attorney docket no. SWAK-001/03US 311665-2007 filed on same date herewith, and entitled “Methods and Apparatus for Distributing, Storing, and Replaying Directives within a Network;” each of which is incorporated herein by reference in its entirety.

In some embodiments, the paths 39 and/or selected images from the set of images 32 can be displayed within a canvas at the display 356. Accordingly, at least a portion of a glyph associated with the paths 39 and/or at least a portion of an image from the set of images 32 can be displayed so that they are visible. In other words, at least a portion of a glyph associated with the paths 39 and/or at least a portion of an image from the set of images 32 can be displayed so that they appear as though they are on top of or within the canvas. In some embodiments, at least a portion of a glyph associated with the paths 39 and/or at least a portion of an image from the set of images 32 can be displayed behind at least a portion of canvas so that the portion of the glyph and/or the portion of the image from the set of images 32 are not visible to (e.g., hidden from view of) a user of the communication device 350. More details related to canvases are discussed in connection with co-pending U.S. patent application bearing attorney docket no. SWAK-003/00US 311665-2003, filed on the same date, and entitled “Methods and Apparatus for Remote Interaction Using a Partitioned Display,” and co-pending U.S. patent application bearing attorney docket no. SWAK-003/01US 311665-2008, filed on the same date, and entitled “Methods and Apparatus for Remote Interaction Using a Partitioned Display,” each of which is incorporated herein by reference in its entirety.

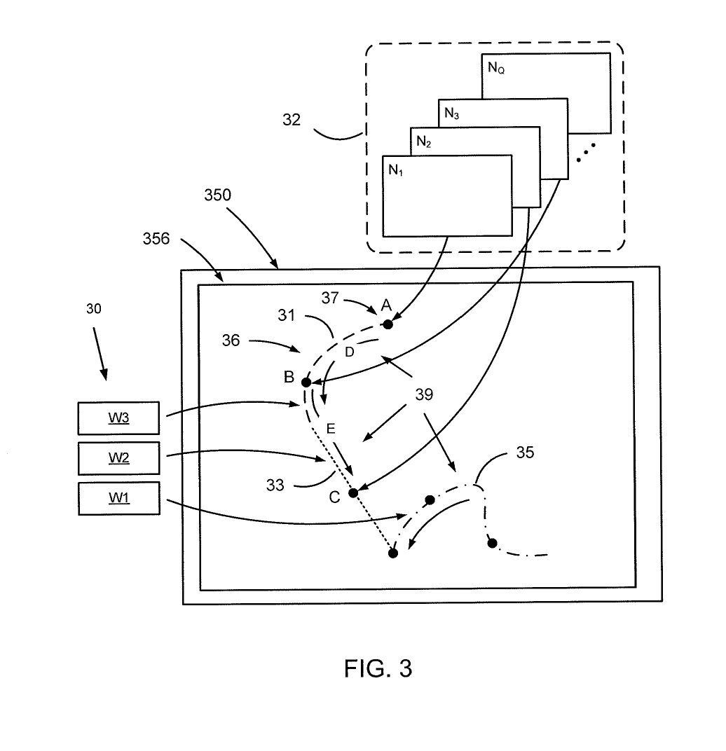

FIG. 4 is a flowchart that illustrates a method for displaying an image from a set of images, according to an embodiment. As shown in FIG. 4, a set of images of an object are received at a communication device, at 400. Each of the images from the set of images can be a perspective view of the object. In some embodiments, the set of images can be selected from a library of sets of images. In some embodiments, the set of images can be received at (e.g., downloaded to) the communication device well before (e.g., days before, weeks before) the set of images are selected and/or displayed. In some embodiments, the set of images can be received at the communication device before, after, or when an application configured to process the set of images is installed.

A directive associated with a portion of a path is received, at 410. In some embodiments, a characteristic of the path, such as a radius of curvature and/or a shape of the path, can be determined based on a parameter value included in the directive.

A set of rules associated with display of at least a portion of the set of images at a display is received, at 420. In some embodiments, the set of rules can be from a user preference and/or can be included in an algorithm executing at the communication device. In some embodiments, the set of rule can be retrieved based on the directive. For example, the set of rules can be selected from a library of rules based on the directive being a particular type of directive (e.g., a directive used to define a curved path). In some embodiments, one or more of the set of rules can be defined (e.g., defined by a user) during run-time of an application configured to process the set of images and/or the directive at the communication device.

An image is selected from the set of images when the portion of the path satisfies a first condition from the set of rules, at 430. In some embodiments, the image can be selected based on an orientation of the portion of the path (which can be defined based on the directive) satisfying the first condition.

A target location is determined based on the portion of the path satisfying a second condition from the set of rules, at 440. In some embodiments, the target location can be selected based on a radius of curvature of the portion of the path (which can be defined based on the directive) satisfying the second condition.

A timing for displaying the image at the target location is determined based on the portion of the path satisfying a third condition from the set of rules, at 450. In some embodiments, the timing can include displaying the image at the target location for a specified period of time and/or displaying the image at a specified time. In some embodiments, the timing can be selected based on a radius of curvature of the portion of the path (which can be defined based on the directive) satisfying the third condition.

An image from the set of images can be selected and displayed at a target location and at a time when the parameter value satisfies a condition within the rule, at 430. In some embodiments, the image can include a particular perspective view of the object. The rule can be defined so that an image with a particular perspective view of an object will be selected for display when the parameter value is satisfied.

In some embodiments, portions of the flowchart illustrated in FIG. 4 can be performed in a different order. In some embodiments, the selection of the image (block 430), the determination of the target location (block 440), and the timing for displaying the image (block 450) can be performed in a different order. For example, the target location where an image should be displayed can be determined before the image is selected. In some embodiments, all or a portion of the flowchart illustrated in FIG. 4 can be performed at a communication device and/or at a host device. If at least some portions of the flowchart are performed at a host device, instructions related to the portions performed at the host device can be communicated to the communication device so that movement of images (and/or glyphs associated with paths) can be displayed at the communication device in a desirable fashion.

In some embodiments, portions of the flowchart can be performed during different communication sessions. For example, the set of images can be received at the communication device (block 400) during a communication session that is mutually exclusive from (and/or before) a communication session during which the directive is received (block 410).

FIG. 5 is a diagram of a table 500 that includes image selection information, according to an embodiment. As shown in FIG. 5, images are represented within the table 500 with an image identifier 520 and are each associated with at least one image resource. The image resources are each represented within the table 500 with an image resource identifier 510. For example, image resource H (shown in column 510) includes images H1 through H4 (shown in column 520).

Also, as shown in FIG. 5, each of the images (represented in column 520) from the image resources (represented in column 510) are associated with an orientation indicator 530. The orientation indicators 530 can indicate an orientation of an object within the images identified within the table 500. For example, image H1 (shown in column 520) is associated with an orientation indicator P-1 (shown in column 530). The orientation indicator P-1 can indicate that the object, as represented within image H1, has a specified orientation with respect to, for example, an origin orientation of the object. Specifically, the orientation indicator P-1 can indicate that the object is rotated (as represented within image H1) 90 degrees around an x-axis (of the object) from an origin orientation of the object and/or is rotated (as represented within image H1) 180 degrees around a y-axis (of the object) from the origin orientation of the object.

Also, as shown in FIG. 5, each of the images (represented in column 520) from the image resources (represented in column 510) are associated with other images included in the table 500 via neighbor relationships 540. The neighbor relationships 540 can indicate which images can be selected and/or displayed after a particular image has been selected and/or displayed at a communication device. For example, image H1 (shown in column 520) is associated, through neighbor relationships, with image H3 and image H4 (shown in column 540). Accordingly, image H3 and/or image H4 can be selected and/or displayed (e.g., displayed at a particular time and/or target location) at a communication device after image H1 has been selected and/or displayed. As shown in FIG. 5, image H2 (shown in column 520) cannot be selected and/or displayed after image H1 has been selected and/or displayed because, as shown in column 540, image H2 is not included in the list of images that has a neighbor relationship with image H1. In some embodiments, neighbor relationships 540 can be defined and used to select and/or display images of an object so that the object, as represented within a display based on the images, can move in a desirable fashion (e.g., can move smoothly without unrealistic jerky movements).

In some embodiments, a communication device can be configured to select and/or trigger display of one or more images along (or near) a path based on one or more of the neighbor relationships 540 included in table 500. For example, image H2 (shown in column 520) can be selected and displayed along a first portion of a path defined within a display of a communication device. The image H2 can be moved along the first portion of the path, which can be defined using a directive, so that movement of an object represented by image H2 can be represented within the display. The image H2 can be selected, displayed, and moved along the first portion of the path at a specified velocity (e.g., speed) based on, for example, a rule, a portion of the directive (e.g., a parameter value included in the directive), and/or a user preference (e.g., a velocity value included in a user preference). The communication device can determine (e.g., determine at a later time), based on a characteristic of the directive (e.g., a radius of curvature of the directive as defined within a parameter value of the directive), that another image should be displayed along a second portion of the path. The communication device can be configured to determine based on the neighbor relationships 540 included in table 500 that image H1 (which has a neighbor relationship with H2) is the next image to be selected for display along the second portion of the path.

In some embodiments, a communication device can be configured to select and/or trigger display of one or more images along (or near) a path based on a combination of one or more of the orientation indicators 530 and one or more of the neighbor relationships 540 included in table 500. For example, image U2 (shown in column 520) can be selected and displayed along a first portion of a path defined within a display of a communication device based on a directive. The communication device can be configured to determine (e.g., determine at a later time) that another image should be displayed along a second portion of the path based on, for example, a characteristic of the directive (e.g., a radius of curvature of the directive as defined within a parameter value of the directive), a user preference, and/or so forth. The communication device can be configured to determine based on the neighbor relationships 540 included in table 500 that the next image should be selected from the following group of images: image U1, image U3, image U4, or image U5 (which have neighbor relationships with U2 as shown in column 540). The communication device can be configured to select image U5 based on the orientation indicator P-5 (shown in column 530) associated with image U5, for example, satisfying a condition within a rule (which can be included in an algorithm and/or a user preference).

In some embodiments, a communication device can be configured to select and/or trigger display of one or more images along (or near) a path based on a combination of one or more of the orientation indicators 530 included in table 500. In other word, the images can be selected and/or displayed without reference to one or more of the neighbor relationships 540 included in table 500. In some embodiments, a communication device can be configured to determine based on radius of curvature of a path (as defined within, for example, a directive) and based on a rule that a sequence of images associated with specified orientation indicators should be displayed starting at one of several target locations along the path. Images can be selected and displayed at the target locations along the path based on the orientation indicators.

For example, a communication device can be configured to determine based on a rule (e.g., a rule within an algorithm) that a first image having an orientation indicator of P-1 should be displayed at a first target location along a path (defined using a directive) and moved towards a second target location along the path. The communication device can be configured to determine based on the rule (e.g., the rule within the algorithm) that a second image having an orientation indicator of P-3 should be displayed at the second target location and moved towards a third target location along the path. The second image can be displayed at the second target location in response to the first image arriving at the second target location. Specifically, the communication device can select image U1 (shown in column 520) from the image resource U (shown in column 510) and display image U1 starting at the first target location along the path because image U1 is associated with orientation indicator P-1 (shown in column 530). Image U1 can be moved from the first target location towards the second target location along the path. In response to the image U1 approaching or arriving at the second target location, the communication device can select image U2 (shown in column 520) from the image resource U (shown in column 510) and display image U2 starting at the second target location along the path because image U2 is associated with orientation indicator P-3 (shown in column 530). Image U2 can be moved from the second target location towards the third target location along the path.

If considering the embodiment described above, image H1 (shown in column 520) could be displayed at the first target location along the path and moved towards a second target location along the path because the image H1 has an orientation indicator of P-1 (shown in column 530). Also, image H2 (shown in column 520) could be displayed at the second target location and moved towards the third target location along the path second image because image H2 has an orientation indicator of P-3 (shown in column 530).

Although not shown, in some embodiments, an image from an image resource identified within table 500 can have a neighbor relationship 540 with another image from a different image resource. For example, in some alternative embodiments, image H2 (shown in column 520) from image resource H (shown in column 510) can have a neighbor relationship with image U3 (shown in column 520) from image resource U (shown in column 510).

In some embodiments, any portion of the image selection information from table 500 can be included in a metadata file that is stored in a memory of a communication device. In some embodiments, portions of the table 500 can be associated with a set of images (shown in column 520), the portions of the table and the set of images can collectively be processed as an image resource (identified within column 510). For example, the portion of the table 500 associated with image resource U (shown in column 510) and the set of images identified within table 500 in column 520 that are included in image resource U can collectively be processed as an image resource. The portion of the table 500 and the set of images included in image resource U can be downloaded from, for example, a host device and stored within a library of image resources. The image resource U, which includes the set of images and the portion of the table 500, can be selected from the library of image resources and processed with respect to a path as a single object by a communication device.

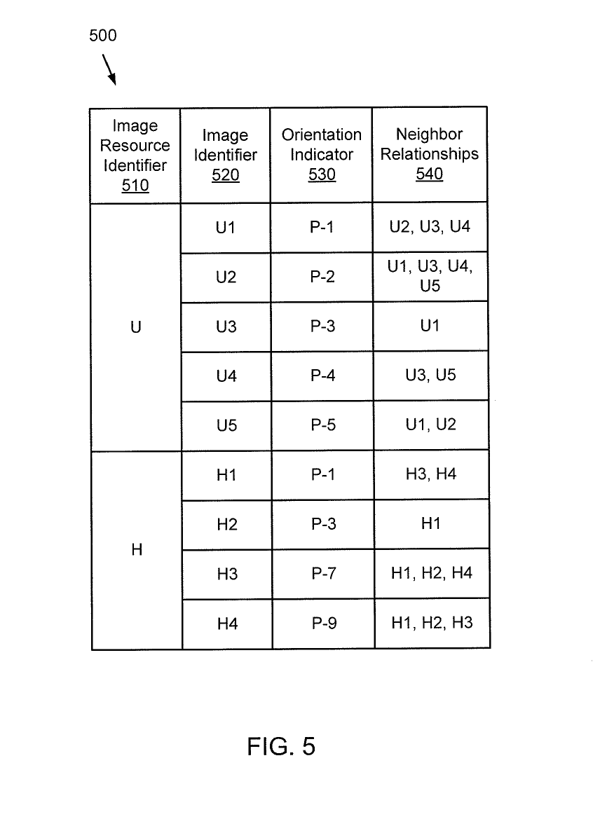

FIG. 6 is a schematic diagram that illustrates orientation indicators associated with images from a set of images 600 and neighbor relationships between images from the set of images 600, according to an embodiment. Each box shown in FIG. 6 represents an image from the set of images 600 and are respectively labeled C₁ through C₁₆. Each image from the set of images 600 can include an illustration of a perspective view of an object.

Each of the images C₁ through C₁₆ includes a set of orientation indicators that indicates the orientation of the perspective view of the object included in each image. Specifically, each of the images from the set of images 600 includes an X orientation indicator and a Y orientation indicator. For example, as shown in FIG. 6, image C₆ is associated with an orientation indicator X=90, which indicates that the object represented by image C₆ is rotated 90 degrees about an x-axis from an origin orientation of the object. Image C₆ is also associated with an orientation indicator Y=90, which indicates that the object represented by image C₆ is rotated 90 degrees about a y-axis from the origin orientation of the object. In some embodiments, the y-axis can be non-parallel to (e.g., orthogonal to) the x-axis. In some embodiments, orientation indicators can be expressed using, for example, polar coordinates and/or any other type of orientation/coordinate system.

In some embodiments, images from the set of images 600 can be selected by a communication device based on the orientation indicators to define a series of images. The series of images can later be displayed (e.g., displayed as the images are being selected, displayed in the order of the series) at the communication device at specified target locations and/or with a specified timing to represent motion of the object depicted in the series of images. For example, a communication device can be configured to define a series of images that will represent movement of the object (which is shown in the set of images 600) around only a Y axis based on a set of rule. The set of rules can be defined so that only selection of images from the set of images 600 that would result in rotations between 45 degrees and less than 100 degrees may be allowed (in some embodiments, a different range of allowable limits can be used so that, for example, faster or slower motion can be represented). If starting with image C₆, the communication device can be configured to select, as shown by the chain of dashed arrows 54 shown in FIG. 6, a series of images including image C₆, image C₇, image C₈, and image C₅.

Image C₇ is selected after image C₆, because selecting any other image from the set of images 600 would violate at least one of the set of rules. For example, image C₈ could not be selected for display after image C₆ because a difference between the Y orientation indicator of C₈ and the Y orientation indicator of image C₆ is greater than 100 degrees. Image C₂, for example, could not be selected for display after image C₆ because image C₂ represents (e.g., depicts an illustration of) the object rotated about an x-axis from an orientation of the object depicted in image C₆ as indicated by the orientation indicators in image C₂ and image C₆, respectively.

Each of the images from the set of images 600 is related to another of the images from the set of images 600 through neighbor relationships (also can be referred to as a map of neighbor relationships). As shown in FIG. 6, the neighbor relationships are represented by dashed lines between images from the set of images 600. For example, image C₆ is related, via neighbor relationship, to image C₂, image C₅, image C₁₁, and image C₁₂.

In some embodiments, images from the set of images 600 can be selected by a communication device based on the neighbor relationships between the images to define a series of images. The series of images can later be displayed (e.g., displayed as the images are being selected, displayed in the order of the series) at the communication device at specified target locations and/or with a specified timing to represent motion of the object depicted in the series of images. For example, as shown in FIG. 6 by the chain of dashed arrows 52, a series of images including image C₁₀, image C₁₁, image C₁₄, image C₁₅, image C₁₆ and image C₁₃ can be defined based on the neighbor relationships between these images. As shown in FIG. 6, image C₁₁ could not have been selected by a communication device after image C₁₅ for inclusion in the series of images because image C₁₁ and image C₁₅ are not related via a neighbor relationship. In some embodiments, selecting images from the set of images 600 based on a map of neighbor relationships can be referred to as traversing a map of neighbor relationships.

Although not shown, in some embodiments, the set of images 600 can also include images that represent (e.g., depict an illustration of) the object rotated about or moved along other axes in addition to an x-axis and a y-axis. For example, the set of images 600 can include images that represent movement of the object along and/or around a z-axis. The z-axis can be non-parallel to (e.g., orthogonal to) the x-axis and/or the y-axis.

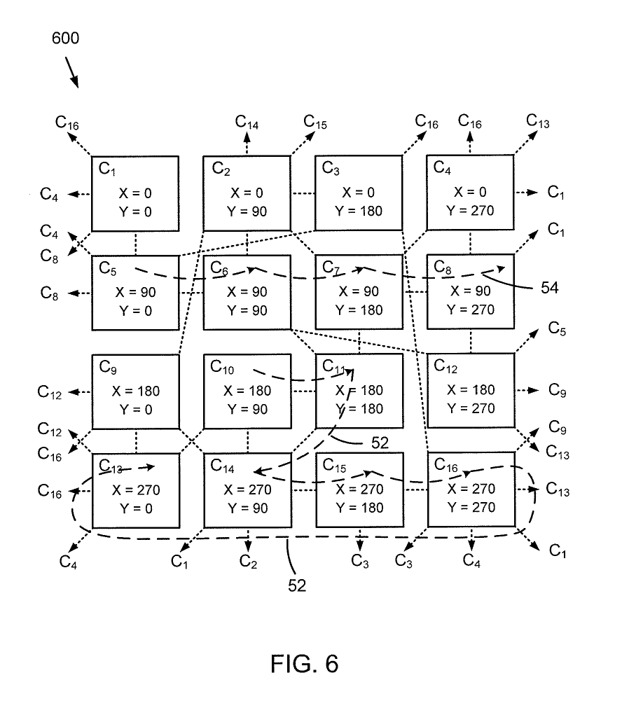

FIG. 7 is a flowchart that illustrates a method for selecting and displaying an image based on a directive and image selection information, according to an embodiment. As shown in FIG. 7, a set of images of an object at a communication device, at 700. Each of the images from the set of images can be a perspective view of the object. In some embodiments, the set of images can be collectively processed as an image resource, and the set of images can be selected from a library of image resources.

Image selection information associated with the set of images can be stored, at 710. The image selection information can be included in, for example, a metadata file associated with the set of images. The metadata file can be collectively processed with the set of images as an image resource. In some embodiments, the image selection information can be include, for example, orientation indicators associated with images from the set of images and/or a map of neighbor relationships between images from the set of images.

Directives are received from a host device, at 720. The directives can be streamed to, for example, the communication device from the host device. The directives can be used to define one or more paths within a canvas (which can be displayed on a display) of the communication device.

At least a portion of a path is defined within a canvas of the communication device based on a directive from the received directives, at 730. In some embodiments, the portion of the path can be defined based on one or more parameter values included in the directive. In some embodiments, a glyph can be defined on the canvas of the communication device based on the directive.

An image is selected from the set of images based on the portion of the path and based on the image selection information, at 740. For example, the image can be selected from the set of images based on a map of relationships and based on a characteristic of the portion of the path. The characteristic of the portion of the path can be, for example, a slope of the portion of the path. In some embodiments, the characteristic of the portion of the path can be determined at the communication device based on the directive. In some embodiments, the characteristic of the portion of the path can be explicitly defined within the directive.

The image is displayed at a target location on the portion of the path, at 740. In some embodiments, the target location can be determined based on, for example, at least a characteristic of the portion of the path.

In some embodiments, portions of the flowchart illustrated in FIG. 7 can be performed in a different order. For example, the image selection information associated with the set of images can be stored (block 710) after the directives are received from the host device (block 720).

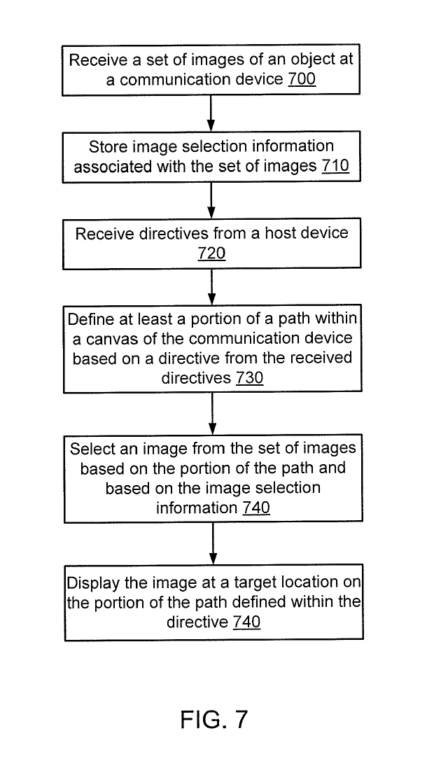

FIG. 8 is a diagram of a table 800 that illustrates a multi-tiered map of neighbor relationships, according to an embodiment. As shown in FIG. 8, images are represented within the table 800 with an image identifier 820 and are each associated with an image resource. The image resource is represented within the table 800 with an image resource identifier 810. For example, image resource S (shown in column 810) includes images S1 through S5 (shown in column 820). The images can represent perspective views of an object.

Also, as shown in FIG. 8, each of the images (represented in column 820) from the image resources (represented in column 810) are associated with other images included in the table 800 via tier-1 neighbor relationships 830 and via tier-2 neighbor relationships 840. The tier-1 neighbor relationships 830 and tier-2 neighbor relationships 840 can indicate which images can be selected and/or displayed after a particular image has been selected and/or displayed at a communication device. For example, image S1 (shown in column 820) is associated, through tier-1 neighbor relationships, with image S2 and image S3 (shown in column 840). Accordingly, image S2 and/or image S3 can be selected and/or displayed (e.g., displayed at a particular time and/or target location) at a communication device after image S1 has been selected and/or displayed.

The different tiers of neighbor relationships can be used to select images from the image resource S so that different types of movement can be represented. The tier-1 neighbor relationships 830 can include neighbor relationships that, when used to select images from the image resource S, will represent faster motion of the object (which is represented within the images) than if the tier-2 neighbor relationships 830 were used to select images from the image resource S.

In some embodiments, the different tiers of neighbor relationships can be used by a communication device based on, for example, a user preference, a rule, and/or a portion of a directive (e.g., a portion of a path defined based on the directive). For example, the tier-1 neighbor relationships 830 can be used to select images from the set of image resources S for display on a first portion of a path, and the tier-2 neighbor relationships 840 can be used to select images from the set of image resources S for display on a second portion of the path. The tier-1 neighbor relationships 830 can be used for the first portion of the path and the tier-2 neighbor relationships 840 can be used for the second portion of the path based on, for example, a rule.

FIG. 9 is an illustration of a directive including a directive description portion and a directive content portion, according to an embodiment. Directive 909 includes directive description portion 919 and directive data portion 929. In some embodiments, directive 909 can include additional portions such as, for example, a length or size portion including a length (e.g., in bytes or bits) of directive 909. Directive description portion 919 can include an identifier or other indicator of a type or class of directive 909. In other words, directive description portion 919 can include a directive class or type identifier. In some embodiments, directive description portion 919 can describe or provide an indication of the contents or format of directive content portion 929. For example, directive description portion 919 can indicate that directive content portion 929 includes one or more of, for example, video data, audio data, image data, textual data, numeric data (e.g., one or more groups of bits representing signed integer values, one or more groups of bits representing unsigned integer values, and/or one or more groups of bits representing floating-point values), operational instructions, and/or control commands. In some embodiments, a directive can include extensible markup language (“XML”) data and/or extensible messaging and presence protocol (“XMPP”) data.

A communication device or a communications session controller can access or read directive description portion 919, to determine how to process or interpret directive 909 or a portion of directive 909 such as directive data portion 929. For example, a communications module can determine how to parse a binary bit string or sequence included in directive content portion 929 based on a directive class identifier included in directive description portion 919. In some embodiments, directive content portion 929 can include encoded data such as, for example, hexadecimal-encoded data or base64-encoded data. A directive class identifier included in directive description portion 919 can provide an indication to, for example, a communication device of the encoding scheme (or schemes) with which the data included in directive content portion 929 is encoded (e.g., a hexadecimal-encoding data scheme or a base64-encoding scheme). In some embodiments, directive content portion 929 can include data representing instructions or commands to be executed by a communication device that receives directive 909. Such instructions or commands can include parameters, characteristics, and/or arguments that can be interpreted or used by a communication device during execution of one or more instructions or commands, and can be referred to as directive parameters or characteristics.

For example, directive content portion 929 can include drawing instructions generated, for example, in response to user input at a first communication device. The drawing instructions can include parameters (e.g., characteristics, arguments and/or representations of glyphs) such as, for example, lines, arcs, geometric figures (e.g., circles, ellipses, and/or polygons), paths, and/or groups of points. A communication device receiving directive 909 can determine how to interpret (or process) the drawing instructions and/or parameters based on directive description portion 919, and draw one or more glyphs, images and/or symbols at a display operatively coupled to that communication device based on the drawing instructions and parameters. Said differently, a display module of a communication device receiving directive 909 can trace or display lines, arcs, paths, geometric figures, and/or points defined within a drawing instruction at a display of that communication device. In other words, a communication device receiving directive 909 can reproduce a symbol such as an image, a glyph, and or collections of the same. that is described by one or more drawing instructions included in directive description portion 929.

In some embodiments, a drawing instruction can include additional parameters such as, for example, line, arc, path, geometric figure, and/or point weights and/or colors, drawing speed or velocity (e.g., a rate at which lines, arcs, paths, geometric figures, and/or points are drawn or displayed to a display operatively coupled to a communication device receiving directive 909), times (e.g., a time period within which lines, arcs, paths, geometric figures, and/or points are drawn or displayed to a display operatively coupled to a communication device receiving directive 909), and/or directionalities (e.g., in which direction to paint or trace a line). In some embodiments, a communication device can include user drawing preferences configured to function as defaults for drawing parameters or instructions that are not included in (or to override) directive content portion 929. For example, a directive class identified by directive description portion 919 can include a drawing instruction that defines a line, but does not define a line weight or color as a parameter. One or more user drawing preferences at a communication device receiving directive 909 can be used by, for example, a display module of that communication device to determine or select a line weight and/or color for the line defined within the drawing instruction of directive content portion 929.

In some embodiments, directive content portion 929 can include image data and/or position and/or orientation data related to one or more images. For example, directive content portion 929 can include a group of base64-encoded images, position information or instructions, and orientation information or instructions for those images. In other words, a communication device can receive directive 909, determine the contents of directive 909 based on a directive class identifier included in directive description portion 919, and display images included in directive content portion 929 at display positions defined (or described) by position parameters of directive description portion 929 and in orientations (e.g., rotational offsets) defined (or described) by orientation parameters of directive description portion 929. In some embodiments, directive content portion 929 can include position and orientation information and/or identifiers of pre-loaded images. The pre-loaded images can be displayed based on the orientation and/or position information in directive portion 929.

In some embodiments, directive 909 can include multiple directive content portions. For example, directive 909 can include images as hexadecimal-encoded image data within directive content portion 929, and position parameters, orientation parameters, and/or other parameters related to those images within another directive content portion. In some embodiments, directives can be complimentary. For example, directive 909 can include images as binary image data (e.g., within directive content portion 929), and another directive can include position parameters, orientation parameters, and/or other parameters related to the images included in directive 909.

In some embodiments, directive 909 can include multiple directive description portions and multiple directive content portions. For example, each directive content portion can related to a directive description portion of a directive. In some embodiments, a single directive description portion can define or describe multiple directive content portions. Similarly, in some embodiments multiple directive description portions can define or describe a single directive content portion.

FIG. 10 is a flowchart that illustrates method 1000 for defining and distributing a group of directives, according to an embodiment. Method 1000 can be implemented, for example, as a software module (e.g., source code, object code, one or more scripts, or instructions) stored at a memory and operable to be executed and/or interpreted or compiled at a processor operatively coupled to the memory at a communication device. For example, processor-executable instructions stored at a memory of a communication device can be executed at a processor at the communication device to cause the processor to execute the steps of method 1000. In some embodiments, method 1000 can be implemented as one or more hardware modules such as, for example, an ASIC, an FPGA, a processor, or other hardware module at a communication device. In some embodiments, method 1000 can be implemented as a combination of one or more hardware modules and software modules at a communication device.

A communication device can associate with a communications session, at 1010. For example, the communication device can respond to an invitation to join or associate with a communications session (e.g., a communications session invitation). In some embodiments, a communication device can send an authentication request (e.g., a communications session authentication request) to a host device or a communications session hosted at the host device to associate with a communications session. In some embodiments, an authentication request can include authentication or authorization information. For example, an authentication request can include a credential (or access or authentication credential) such as a password, authentication challenge response, an encrypted message (such as an encrypted unique identifier of the communication device or a user of the communication device), a digital digest or hash, a digital certificate, and/or unique identifier. The host device can authenticate the communication device (or user of the communication device) with the communications session based on the credential. In other words, the host device can determine that the communication device (or the user of the communication device) is authentic (e.g., the entity it claims to be) and/or that the communication device (or the user of the communication device) is authorized to access the communication device based on the credential.

For example, a credential can be a unique identifier of a user of the communication device that is encrypted with a private key associated with that user. The host device can decrypt the unique identifier with a public key corresponding to the private key with which the unique identifier was encrypted to determine that the user of the communication device is authentic. Additionally, the host device can access a list of unique identifiers that are authorized to access the communications session. If the unique identifier included in the credential is included in the list, the host device can determine that the user of the communication device is authorized to access the communications session. In some embodiments, a unique identifier (e.g., a unique identifier of a user) can be related to or associated with a communication device. For example, the unique identifier can be a hardware identifier or address, or a network identifier or address of a communication device.

In some embodiments, a communications session can be a connection or relationship such as, for example, a logical connection, a virtual connection, or physical connection between one or more communication devices and a communications session controller. Individual connections (e.g., logical, virtual, or physical) between a single communication device and a communications session controller can be referred to as communications session links. A communications session can include the communications session controller and the communications session links between communication devices and the communications session controller. Thus, communication devices can communicate (e.g., send directives to) one with another via the communications session by passing or relaying that communication through a communications session controller hosted at a host device via communications session links. In other words, each communication device can send directives to the communications session controller via communication session links, and the communications session controller can distribute those directives to the other communication devices connected to (or associated with) the communications session via other communications session links. This process can be referred to as communicating (e.g., sending and receiving directives) via the communications session.

The communication device can receive parameters of the communications session, at 1020. A communications session can include various parameters to, for example, define characteristics and/or data formats or values that are valid within that communications session. For example, a particular communications session can be related to transmission of textual data, and a parameter of communications session can define encoding (e.g., UTF-8, UTF-16 or UTF-32) of textual data that is transmitted via the communications session. In some embodiments, communications session parameters can be transmitted within directives of a parameter directive class. In some embodiments, parameters of a communications session can define other aspects or properties of a communications session such as, for example, which participants of the communications session (e.g., communication devices that are associated with the communications session) can send directives (e.g., to other communication devices associated with the communications session) via the communications session, and which participants of the communications session (also referred to as “participants”) can receive directives.

In some embodiments, one or more parameters of a communications session can describe or define which directive classes are valid within the communications session. In other words, a communications session can impose limits on which directive classes are distributed via the communications session, and/or which directive classes client applications or programs executing at a communication device can support (e.g., process and/or interpret) to be compliant or compatible with that communications session. In some embodiments, a communications session can disassociate from or leave a communications session if the communication device does not support or comply with one or more communications session parameters. In some embodiments, a communications session controller can disconnect from or disassociate with communication devices that do not comply with one or more parameters of that communications session. In some embodiments, parameters of a communications session can be negotiated between communication devices and the communications session controller. For example, parameters can be negotiated to determine which parameters are compatible with a majority of the communication devices, or which parameters (e.g., security parameters) offer the most secure communications session without violating minimum security standards or requirements. In some embodiments, a communication device can partition or configure itself (or one or more client applications related to the communications session) in response to the communications session parameters received, at 1020.

After the communication device has received communications session parameters, at 1020, and/or provisioned or configured the communication device in response to the communications session parameters, user input can be detected, at 1030. For example, a communication device can include a user input device such as a touch screen and/or other user input devices such as a mouse, a camera, a microphone, an accelerometer, and/or a global positioning system (“GPS”) module configured to generate sensor data in response to user interaction with the user input device. The communication device (or a user interface or input module of or operatively coupled to the communication device) can detect contact points, gestures, or movement of the user with respect to the user input device using, for example, sensors operatively coupled to the user input device to generate the sensor data. In some embodiments, the sensor data can be generated by motion, objects, and/or other input detected by a camera, by movement of the communication device (e.g., detected via one or more accelerometers, gyroscopes, inertial measurement units (“IMUs”), and/or GPS modules), aural or audio input detected by a microphone, and/or by other input. The communication device can then define a data set, at 1040, based on at least a portion of the sensor data.

A data set can be, for example, a portion of sensor data detected at a user input device of the communication device. In some embodiments, the data set can be a portion of sensor data representing a gesture such as, for example, a line, arc or path of the gesture. In other words, the data set can include a start point and an end point of a line with respect to an absolute or relative coordinate system such as, for example, a display or a canvas. Additionally, the data set can include a start point, an end point, and a radius of an arc, and/or a series of points defining a path. Other examples of data sets include image sensor (or camera) data and/or movement (or motion) data. In some embodiments, a data set can be compressed via a compression algorithm to minimize the size or length of a directive and/or to maximize or improve throughput of the communications session or one or more communications session links of the communications session.

In some embodiments, one data set can include one type of data and another data set can include a different type of data. For example, one data set can include lines, arcs, points, and/or paths derived from a gesture input at a touch screen operatively coupled to the communication device, and another data set can include drawing rates (e.g., speed of a gesture) related to these lines, arcs, points, and/or paths. A communication device receiving directives including these data sets can reproduce the gesture (e.g., as one or more glyphs) at a display operatively coupled to that communication device in form as well as at the rate the gesture was made at the source communication device. In other words, the gesture can be reproduced serially one per gesture basis at the destination communication device at the same (or substantially the same) rate or speed and in the same (or substantially the same) form as at the source communication device.

In some embodiments, the user input detected at 1030 can be used to select or provide an indication of a data set to be defined at 1040. For example, a user can indicate an image file, a video file, an audio file, a symbol, a message, or an image resource to be included in one or more directives. In other words, the user can select, for example, a video file (or a portion thereof) that is to be included in a directive as a data set within a directive content portion of that directive, and distributed via a communications session. In some embodiments, the video file can be distributed across multiple directives (e.g., portions of the file are defined as data sets and transmitted in multiple directives).

After the data set has been defined, a description of the data set is defined, at 1050. For example, an identifier or indication of a directive class representing the data set can be defined. The description of the data set can indicate, for example, a source of the data set, the type of data included in the data set, the format of data included in the data set, the number of data values in the data set, the length (e.g., in bytes or bits) of the data set, whether a data set is compressed and the type of compression, and/or other characteristics of the data set. In some embodiments, the description can identify a processing module (e.g., a software module, a general purpose processor, or an ASIC) or a configuration of a processing module that can process or interpret the data set.

The description and the data set can be included in a directive description portion and a directive content portion of a directive, respectively, at 1060. In other words, a directive can be defined based on the description defined at 1050 and the data set defined at 1040. In some embodiments, other portions of the directive can also be populated or defined, at 1060. For example, the length (e.g., in byte) of the directive can be calculated and included in a portion of the directive, and/or a source identifier such as a hardware or network identifier of the source communication device of the directive can be included in another portion of the directive.

The directive can then be sent (e.g., to a communications session controller of the communications session), at 1070, and the communication device can determine, at 1081, whether more data are included in the user input detected at 1030. If there are more data in the user input (e.g., additional lines, arcs, paths, and/or points within sensor data representing a gesture detected at a touch screen), the communication device can return to step 1040 and define another data set. In some embodiments, one data set can be associated with a description related to a first directive class, and another data set can be associated with a description related to a second directive class. In other words, directive of multiple directive classes can be defined in response to a single user input or form of user input. In some embodiments, a single directive class can describe a single user input. If there are no more data in the user input (or there is an end indication from the user), the communication device can determine, at 1082, whether the communication device is disassociated (or disconnected) from the communications session. If the communication device is disassociated from the communications session, the communication device can stop (or end) method 1000, at 1090. If the communication device is not disassociated from the communications session (i.e., the communication device is still connected to or in communication with the communications session controller) at 1082, the communication device can return to step 1030 to detect additional user input.

In some embodiments, method 1000 can include more or fewer steps than illustrated in FIG. 10. For example, method 1000 can include initiating the communications session and or sending a disassociation signal to the communications session controller. Additionally, in some embodiments, steps of method 1000 can be rearranged. As illustrated in FIG. 10, directives are defined and sent in real-time. In other words, directives are sent serially as they are defined at the communication device. For example, the first directive can be defined and sent before the user has provided input for the third directive. In some embodiments, the steps of method 1000 can be rearranged, and multiple directives can be defined before any are sent. For example, directives representing all the user input detected at step 1030 can be defined before any directives are sent. As another example, directives including an entire image file selected by user input from a user for distribution via the communications session can be defined before any of these directives are sent. In some such embodiments, all the directives that are defined based on the user input can be sent at substantially the same time (e.g., the directives can be loaded into a transmission buffer and sent serially to the communications session controller for distribution via the communications session controller).

In some embodiments, directives can include (e.g., within a directive content portion) one or more instructions that cause a communication device receiving a directive to produce some output based on the directive. For example, a communication device can display a message or update a context (e.g., a portion) of a display in response to a directive. In some embodiments, a directive can include audio and/or video data and that data can be played at the communication device. In some embodiments, images can be manipulated and/or drawing at a display can occur in response to a directive.

Some embodiments described herein relate to a computer storage product with a computer- or processor-readable medium (also can be referred to as a processor-readable medium) having instructions or computer code thereon for performing various computer-implemented operations. The media and computer code (also can be referred to as code) may be those designed and constructed for the specific purpose or purposes. Examples of computer-readable media include, but are not limited to: magnetic storage media such as hard disks, floppy disks, and magnetic tape; optical storage media such as Compact Disc/Digital Video Discs (“CD/DVDs”), Compact Disc-Read Only Memories (“CD-ROMs”), and holographic devices; magneto-optical storage media such as optical disks; carrier wave signal processing modules; and hardware devices that are specially configured to store and execute program code, such as general purpose microprocessors, microcontrollers, Application-Specific Integrated Circuits (“ASICs”), Programmable Logic Devices (“PLDs”), and Read-Only Memory (“ROM”) and Random-Access Memory (“RAM”) devices.

Examples of computer code include, but are not limited to, micro-code or micro-instructions, machine instructions, such as produced by a compiler, code used to produce a web service, and files containing higher-level instructions that are executed by a computer using an interpreter. For example, embodiments may be implemented using Java™, C++, or other programming languages (e.g., object-oriented programming languages) and development tools. Additional examples of computer code include, but are not limited to, control signals, encrypted code, and compressed code.

While various embodiments have been described above, it should be understood that they have been presented by way of example only, not limitation, and various changes in form and details may be made. For example, although certain methods of authentication are discussed, other authentication methods can be used. Any portion of the apparatus and/or methods described herein may be combined in any combination, except mutually exclusive combinations. The embodiments described herein can include various combinations and/or sub-combinations of the functions, components and/or features of the different embodiments described. For example, in some embodiments, features of one module described herein can be included in another module to reduce the number of discrete components of an apparatus. Additionally, in some embodiments, for example, some modules described herein can be implemented in software or code executing on a processor and other modules can be implemented in hardware such as application-specific integrated circuits or semiconductor chips.

What is claimed is:

1. A processor-readable medium storing code representing instructions that when executed by a processor cause the processor to:
receive a set of directives from a host device, the set of directives defining an aspect of a media resource;
define a set of target locations within a canvas displayed at a communication device based on the set of directives; and
select from a set of images an image for display at a target location from the set of target locations based on the set of directives, each image from the set of images representing a perspective view of an object.

2. The processor-readable medium of claim 1, wherein the target location is a first target location,
the processor-readable medium further storing code representing instructions that when executed by the processor cause the processor to:
move the image from the first target location towards a second target location from the set of target locations.

3. The processor-readable medium of claim 1, wherein the media resource is at least one of a visual resource or an audio resource.

4. The processor-readable medium of claim 1, wherein the media resource is a glyph displayed within the canvas, the target location is at a specified distance from a portion of the glyph.

5. The processor-readable medium of claim 1, wherein the set of directives are received at the communication device from the host device, the set of images are stored at the communication device before the set of directives are received at the communication device.

6. The processor-readable medium of claim 1, wherein the target location is identified within a directive from the set of directives.

7. The processor-readable medium of claim 1, wherein the communication device is a first communication device, the set of directives are defined at a second communication device in response to an interaction of a user with the second communication device.

8. The processor-readable medium of claim 1, wherein the image is associated with an orientation indicator, the image is selected based on an algorithm using the orientation indicator.

9. The processor-readable medium of claim 1, wherein the image is selected based on a map of neighbor relationships between images from a set of images.

10. A processor-readable medium storing code representing instructions that when executed by a processor cause the processor to:
store a set of orientation indicators associated with images from a set of images of an object, each orientation indicator from the set of orientation indicators representing a perspective view the object; and
select, from the set of images, an image of the object in a specified orientation based on the set of orientation indicators and based on a directive configured to trigger display of a glyph on a canvas of a communication device.

11. The processor-readable medium of claim 10, wherein the directive is received at the communication device from a host device.

12. The processor-readable medium of claim 10, further storing code representing instructions that when executed by the processor cause the processor to:
send a request for a stream of directives to a host device via a network; and
receive the stream of directives in response to the request, the directive being from the stream of directives.

13. The processor-readable medium of claim 10, wherein the image is a static image.

14. The processor-readable medium of claim 10, wherein the communication device is a first communication device,
the processor-readable medium further storing code representing instructions that when executed by the processor cause the processor to:
receive a stream of directives from a host device via a network, the directive being from the stream of directives, each directive from the stream of directives having an order within the stream of directives defined at a second communication device different from the first communication device.

15. The processor-readable medium of claim 10, wherein the image of the object in the specified orientation is selected based on a characteristic of the glyph, the characteristic is represented within the directive.

16. The processor-readable medium of claim 10, wherein the set of orientation indicators is included in a metadata file associated with the set of images.

17. The processor-readable medium of claim 10, wherein the set of images are collectively processed at the communication device as a single image resource.

18. A processor-readable medium storing code representing instructions that when executed by a processor cause the processor to:
store a predefined map of neighbor relationships between images from a set of images, each image from the set of images representing a perspective view of an object, at least one image from the set of images having a nearest neighbor relationship with more than two images from the set of images;
receive a set of directives from a host device;
select a first image from the set of images based on a first directive from the set of directives; and
select a second image associated with the first image based on a second directive from the set of directives and based on the predefined map of neighbor relationships.

19. The processor-readable medium of claim 18, further storing code representing instructions that when executed by the processor cause the processor to:
move the first image along a portion of a glyph displayed at a communication device based on the first directive.

20. The processor-readable medium of claim 18, wherein the set of directives are received from the host device as a stream of directives,
the processor-readable medium further storing code representing instructions that when executed by the processor cause the processor to:
identify the second directive as a final directive from the stream of directives; and
trigger display of a default sequence of images from the set of images in response to the second directive being identified as the final directive.

21. The processor-readable medium of claim 18, wherein the first directive and the second directive are collectively configured to trigger display of a glyph defining at least a portion of an alphanumeric character.

22. The processor-readable medium of claim 18, further storing code representing instructions that when executed by the processor cause the processor to:
select a third image having a neighbor relationship with the second image based on the second directive;
trigger display of a glyph based on the second directive during a time period;
trigger display of the second image during a first portion of the time period; and
trigger display of the third image during a second portion of the time period mutually exclusive from the first portion of the time period.

23. The processor-readable medium of claim 18, further storing code representing instructions that when executed by the processor cause the processor to:
trigger display of a glyph based on the first directive;
trigger display of a glyph based on the second directive; and
trigger display of the second image along a path between the glyph associated with the first directive and the glyph associated with the second directive.

24. The processor-readable medium of claim 18, wherein the set of directives define a message from a user.

25. The processor-readable medium of claim 18, wherein the map of neighbor relationships is included in a metadata file associated with the set of images, the image of the object in the specified orientation is selected based on a representation of the specified orientation within the metadata file.
